(19) United States
(12) Patent Application Publication
(10) Pub. No.: US 2006/0048063 A1
(43) Pub. Date: Mar. 2, 2006

(54) Design request form

(75) Inventors: Jennifer Stackowicz, Corona, CA (US); Chet Winney, Yorba Linda, CA (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/924,741

(22) Filed: Aug. 24, 2004

(51) Int. Cl. G06F 3/00; G06F 17/24; G06F 17/21

(52) U.S. Cl. 715/764; 715/501.1; 715/517; 715/530

(57) ABSTRACT

A design request form comprises a style selection portion having a plurality of user-selectable design styles from which one or more design styles suited to a product, business or service of a potential advertiser in a telephone directory are selectable by a sales representative. The style selection portion provides a plurality of user-selectable links to a plurality of style pages for the design styles. The style pages provide visual representations of sample telephone directory advertisements having the design styles and creative interpretations of the design styles. The samples and creative interpretations are usable by a designer to design a telephone directory advertisement for the potential advertiser based on which one or more of the design styles are selected.

### FIELD OF THE INVENTION

The present disclosure relates to methods for creating speculative advertisements (spec ads) for a telephone directory.

### DESCRIPTION OF THE RELATED ART

A process for creating a spec ad for a telephone directory such as the Yellow Pages® involves three parties: an advertiser, a sales representative and a designer. The advertiser includes one or more individuals that the sales representative wishes to pitch placing an ad in the directory. The advertiser provides to the sales representative ad-specific information and verbal guidance on how the spec ad is to look. The sales representative forwards this information to the designer, who is to create a draft of the spec ad based on the information. The information may be contained on a form that is filled out by the sales representative and forwarded to the designer. In many cases, the amount of information given to the designer is insufficient for the designer to create a desired result without receiving further information or suggestions.

The designer provides a draft of the spec ad for review by the sales representative and the advertiser. If the advertiser's and/or the sales representative's expectations are not met by the draft, the designer is requested to create another draft. Thus, the designer may be required to create one or more additional drafts—which cost time and money—until the expectations and the desired result are met.

### BRIEF DESCRIPTION OF THE DRAWINGS

The present invention is pointed out with particularity in the appended claims. However, other features are described in the following detailed description in conjunction with the accompanying drawings in which:

FIG. 1 is a screen shot of an embodiment of a design request form;

FIG. 2 is a screen shot of an embodiment of a style page corresponding to a flashy style;

FIG. 3 is a screen shot of an embodiment of a style page corresponding to a classic/nostalgic style;

FIG. 4 is a screen shot of an embodiment of a text effects page;

FIG. 5 is a screen shot of an embodiment of a color preferences page;

FIG. 6 is a screen shot of an embodiment of a font preferences page; and

FIG. 7 is a block diagram of a system for using a design request form.

### DETAILED DESCRIPTION OF THE PREFERRED EMBODIMENTS

Disclosed herein are embodiments of a design request form that enable a sales representative and/or an advertiser to identify and check off specific instructions and/or design styles when a spec ad is requested for a product, business or service of the advertiser. The design request form and/or information gathered thereby are forwarded to a designer to create a draft of a spec ad based thereon.

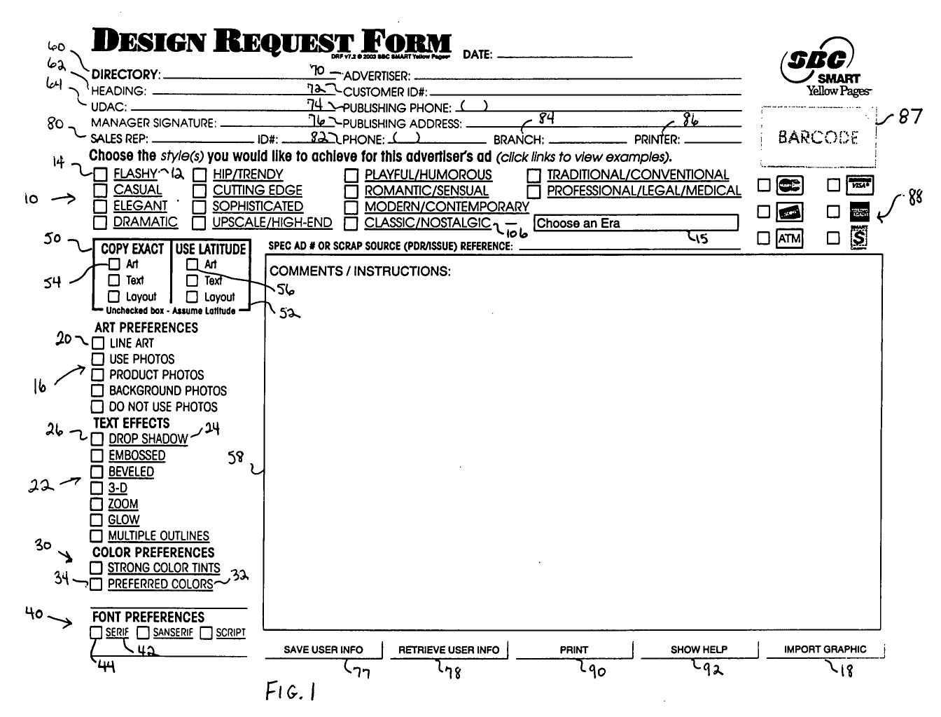

FIG. 1 is a screen shot of an embodiment of a design request form. The design request form comprises multiple fields and portions to receive various instructions and/or selections made by a sales representative and/or an advertiser.

The design request form may be embodied electronically, e.g. as one or more interactive electronic pages displayed to the sales representative and/or the advertiser using a computer. The sales representative and/or the advertiser inputs the instructions and/or selections to the electronic page(s) using one or more input devices such as a keyboard, mouse, touch pad, or voice input device. In one embodiment, the design request form is a multi-platform document that requires no specialized software installation, programming or IS/IT support. The multi-platform document may comprise one or more pages viewable using a document viewer program. For example, multiple pages of the design request form can be stored as a PDF file for viewing and user interaction using the Adobe® Acrobat® Reader® program. In another example, the multi-platform document may comprise one or more pages viewable using a browser program such as Microsoft® Internet Explorer®. The multi-platform document can be stored as computer-readable program code on a computer-readable medium to cause a computer to provide its functionality.

Alternatively, the design request form may be embodied as a hard copy, e.g. one or more printed pages of paper on which the sales representative and/or the advertiser can write the instructions and/or selections using a pen, pencil, or other writing implement. Without loss of generality, the detailed description herein focuses on electronic embodiments of the design request form.

The design request form comprises a style selection portion 10. The style selection portion 10 lists multiple design styles to help the sales representative and/or advertiser identify and select a style (e.g. a look and feel) that is deemed to be best suited with the advertiser's product, business or service. In the embodiment of FIG. 1, the multiple design styles comprise a flashy style, a casual style, an elegant style, a dramatic style, a hip/trendy style, a cutting edge style, a sophisticated style, an upscale/high-end style, a playful/humorous style, a romantic/sensual style, a modern/contemporary style, a classic/nostalgic style, a traditional/conventional style and a professional/legal/medical style. In alternative embodiments, however, more, fewer, and/or other design styles may be included.

The multiple design styles are provided because consumers are attracted by the style, look or feel a product possesses whether it be a new home, car, clothes, food or services, for example. The strong influence of style is witnessed in various forms of advertising such as television commercials, magazines, billboards, radio, shopping malls, and restaurants. However, in Yellow Pages® advertising, the same type of association to style is not exhibited. The focus of Yellow Pages® advertising has heretofore been on communicating the product or service using images and colors as primary tools to capture consumers' attention, in a manner that can appear to be undefined or void of particular styles.

Associated with each of the multiple design styles is a corresponding user-selectable link to a corresponding style page. A representative one of the user-selectable links is indicated by reference numeral 12. Each style page provides a visual representation of at least one sample ad having its corresponding design style, a descriptive definition of its corresponding design style, and a creative interpretation. The descriptive definition may be based on a dictionary definition, e.g. a definition provided by a Webster's® Dictionary, of the name of its design style. In the embodiment of FIG. 1, each user-selectable link is provided by clicking on or otherwise selecting a corresponding textual name of a corresponding design style listed in the portion 10. In alternative embodiments, however, the user-selectable links can be provided by other user-selectable items in the portion 10.

Also associated with each of the multiple design styles is a corresponding selector region. A representative one of the selector regions is indicated by reference numeral 14. Each selector region is user-selectable to allow a selection of its corresponding style to be made. Optionally, each selector region toggles back and forth between an unselected state and a selected state as repeated user-initiated selections are made thereto. In the embodiment of FIG. 1, each selector region in the portion 10 and in other subsequently-described portions comprises a corresponding graphical check box. In alternative embodiments, each selector region may have alternative forms such as a graphical radio button for example.

If the classic/nostalgic style is selected, any particular era from a set of eras is user-selectable via a selection box 15. Examples of the eras in the set include 1920s, 1930s, 1940s, 1950s, 1960s, 1970s, 1980s and Old World. As an alternative to selecting a particular era from the set, the user can enter text which describes the era directly into the box 15. The user may directly enter text, for example, if he/she is interested in an era that is not included in the standard set of eras.

The design request form may accept multiple style selections per spec ad. For example, the check boxes for flashy, humorous, and nostalgic 1950s look all can be selected to request a combined style for one spec ad. In other embodiments, only one style selection per spec ad may be accepted.

The design request form further comprises an art preferences selection portion 16. The art preferences selection portion 16 lists multiple art preferences to help the sales representative and/or advertiser identify and select one or more art preferences for the spec ad. In the embodiment of FIG. 1, the multiple art preferences comprise a preference to use of line art, a preference to use of photo(s), a preference to use of product photo(s), a preference to use of background photo(s), and a preference to not use any photo(s). In alternative embodiments, however, more, fewer, and/or other art preferences may be included in the portion 16.

Graphics such as logos and/or product photos, background photos or other photos for use in the spec ad can be imported by clicking on or otherwise selecting an import graphic button 18. The imported graphics are forwarded to the designer in addition to a completed design request form. In one embodiment, the graphics have a PDF format. In other embodiments, the graphics can have any graphic or image format such as TIFF, JPEG, or GIF, for example. The imported graphics may comprise a PDF of a previous year's ad for the advertiser, for example.

Associated with each of the multiple art preferences is a corresponding selector region. A representative one of the selector regions is indicated by reference numeral 20. Each selector region is user-selectable to allow a selection of its corresponding art preference to be made. Optionally, each selector region toggles back and forth between an unselected state and a selected state as repeated user-initiated selections are made thereto. The design request form may accept multiple art preference selections per spec ad, or in other embodiments may accept only one art preference selection per spec ad.

The design request form further comprises a text effects selection portion 22. The text effects selection portion 22 lists multiple text effects to help the sales representative and/or advertiser identify and select one or more effects to apply to text in the spec ad. In the embodiment of FIG. 1, the multiple text effects comprise a drop shadow effect, an embossed effect, a beveled effect, a 3-D effect, a zoom effect, a glow effect, and a multiple outlines effect. In alternative embodiments, however, more, fewer, and/or other text effects may be included in the portion 22.

Associated with each of the multiple text effects is a corresponding user-selectable link to a corresponding text effects page. A representative one of the user-selectable links is indicated by reference numeral 24. Each text effects page provides a visual example of text having its corresponding text effect. In the embodiment of FIG. 1, each user-selectable link is provided by clicking on or otherwise selecting a corresponding textual name of a corresponding text effect listed in the portion 22. In alternative embodiments, however, the user-selectable links can be provided by other user-selectable items in the portion 22.

Also associated with each of the multiple text effects is a corresponding selector region. A representative one of the selector regions is indicated by reference numeral 26. Each selector region is user-selectable to allow a selection of its corresponding text effect to be made. Optionally, each selector region toggles back and forth between an unselected state and a selected state as repeated user-initiated selections are made thereto. The design request form may accept multiple text effect selections per spec ad, or in other embodiments may accept only one text effect selection per spec ad.

The design request form further comprises a color preferences selection portion 30. The color preferences selection portion 30 lists multiple color preferences to help the sales representative and/or advertiser identify and select one or more effects preferences to how color is to be used in the spec ad. In the embodiment of FIG. 1, the multiple color preferences comprise a preference for strong color tints, and a preference for preferred colors. In alternative embodiments, however, more, fewer, and/or other color preferences may be included in the portion 30.

Associated with each of the multiple color preferences is a corresponding user-selectable link to a corresponding color preferences page. A representative one of the user-selectable links is indicated by reference numeral 32. Each color preferences page provides visual examples of its corresponding color preference. In the embodiment of FIG. 1, each user-selectable link is provided by clicking on or otherwise selecting a corresponding textual name of a corresponding color preference listed in the portion 30. In alternative embodiments, however, the user-selectable links can be provided by other user-selectable items in the portion 30.

Also associated with each of the multiple color preferences is a corresponding selector region. A representative one of the selector regions is indicated by reference numeral 34. Each selector region is user-selectable to allow a selection of its corresponding color preference to be made. Optionally, each selector region toggles back and forth between an unselected state and a selected state as repeated user-initiated selections are made thereto. The design request form may accept multiple color preference selections per spec ad, or in other embodiments may accept only one color preference selection per spec ad.

The design request form further comprises a font preferences selection portion 40. The font preferences selection portion 40 lists multiple font preferences to help the sales representative and/or advertiser identify and select one or more fonts to apply to text in the spec ad. In the embodiment of FIG. 1, the multiple font preferences comprise a serif font, a sanserif font, and a script font. In alternative embodiments, however, more, fewer, and/or other font preferences may be included in the portion 40.

Associated with each of the multiple font preferences is a corresponding user-selectable link to a corresponding font preferences page. A representative one of the user-selectable links is indicated by reference numeral 42. Each font preferences page provides a visual example of text having its corresponding font. In the embodiment of FIG. 1, each user-selectable link is provided by clicking on or otherwise selecting a corresponding textual name of a corresponding font preference listed in the portion 40. In alternative embodiments, however, the user-selectable links can be provided by other user-selectable items in the portion 40.

Also associated with each of the multiple font preferences is a corresponding selector region. A representative one of the selector regions is indicated by reference numeral 44. Each selector region is user-selectable to allow a selection of its corresponding font preference to be made. Optionally, each selector region toggles back and forth between an unselected state and a selected state as repeated user-initiated selections are made thereto. The design request form may accept multiple font preference selections per spec ad, or in other embodiments may accept only one font preference selection per spec ad.

The design request form further comprises a “copy exact” selection portion 50 and a “use latitude” selection portion 52. The portion 50 enables the sales representative and/or advertiser to direct the designer to use an exact copy of art, text or layout provided to him/her when designing the spec ad. The portion 52 enables the sales representative and/or advertiser to direct the designer to use latitude in modifying art, text or layout provided to him/her when designing the spec ad. The choice of “copy exact” and “use latitude” is independently selectable for each characteristic (art, text or layout). If a characteristic is not selected, it is assumed that the designer is to be given latitude for that characteristic.

Associated with each of the characteristics in each of the portions 50 and 52 is a corresponding selector region. Representative ones of the selector regions are indicated by reference numerals 54 and 56. Each selector region is user-selectable to allow a selection of its corresponding exact/latitude preference to be made. Optionally, each selector region toggles back and forth between an unselected state and a selected state as repeated user-initiated selections are made thereto.

Textual comments and instructions regarding the spec ad are entered by the user into a text box 58.

The design request form includes user-enterable fields 60 and 62 to receive information indicating which directory is to include the spec ad, and under which heading the spec ad is to appear in the directory. User-enterable field 64 is to receive UDAC information that indicates a size of the spec ad.

User-enterable fields 70, 72, 74 and 76 are to receive information identifying a name of the advertiser, a customer identification number for the advertiser, a published telephone number for the advertiser, and a published address for the advertiser, respectively. The information entered into the fields 70, 72, 74 and 76 may be saved to a computer-readable storage medium, which may or may not include a database, in response to the user selecting a “save user info” button 77. For example, the full version of Adobe® Acrobat® Reader® allows a user to save the fields of one page without using a database. For existing customers, one or more of the fields 70, 72, 74 and 76 may be automatically populated from the computer-readable storage medium, which may or may not include the database, in response to the user selecting a “retrieve user info” button 78.

Other user-enterable fields 80, 82, 84 and 86 are to receive information identifying the sales representative, his/her telephone number, his/her sales branch, and a printer at which proofs are printed for him/her, respectively. One or more of the fields 80, 82, 84 and 86 may be automatically populated by static sales representative information stored locally in the computer. This reduces the likelihood of the sales representative having to enter repetitive data. A bar code 87 encodes a reference number or another code to identify the spec ad. Optionally, one or more of the fields 70, 72, 74, 76, 80, 82, 84 and 86 may be automatically populated in response to the sales representative entering a customer identifier.

A payment selection portion 88 receives a user selection of which one or more payment options (e.g. credit cards, debit cards, telephone directory coupons) are accepted by the advertiser and whose payment logo(s) are to appear in the spec ad. A user selection of a print button 90 initiates the design request form with the user-entered information to be printed.

A user selection of a help button 92 toggles between a show-help mode and a hide-help mode. In the show-help mode, help instructions specific to a portion of the design request form are displayed in the text box 58 when a mouse-over event occurs for that portion. For example, when a pointing-device cursor is pointing to the style selection portion 10, comments and instructions associated with the style selection portion 10 are displayed in the text box 58.

The embodiment of the design request form in FIG. 1 has been designed to take under a minute, and in many cases approximately 30 seconds to fill out. The form can be completed either electronically or manually.

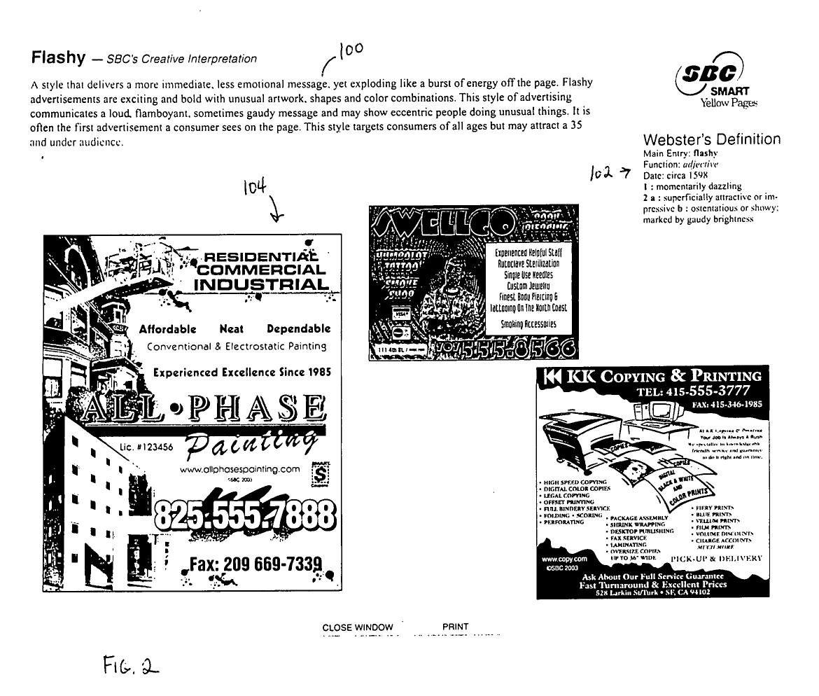

FIG. 2 is a screen shot of an embodiment of a style page corresponding to the flashy style. The flashy style page is displayed in response to a user selection of the link 12 in FIG. 1. The flashy style page displays a creative interpretation 100 of the flashy style, a definition 102 of flashy, and examples of flashy style ads 104.

The creative interpretation 100 textually describes the flashy style. The creative interpretation 100 describes that the flashy style “delivers a more immediate, less emotional message, yet exploding like a burst of energy off the page.” The creative interpretation 100 describes what kind of artwork, shapes and color are to be in the ad with the sentence: “Flashy advertisements are exciting and bold with unusual artwork, shapes and color combinations.” The creative interpretation 100 describes the type of message communicated by the flashy style in the sentence: “This style of advertising communicates a loud, flamboyant, sometimes gaudy message and may show eccentric people doing unusual things.” The creative interpretation 100 describes how flashy style ads in telephone directories are viewed by consumers in the sentence: “It is often the first advertisement a consumer sees on the page.” The creative interpretation 100 provides targeting information in the sentence: “This style targets consumers of all ages but may attract a 35 and under audience.”

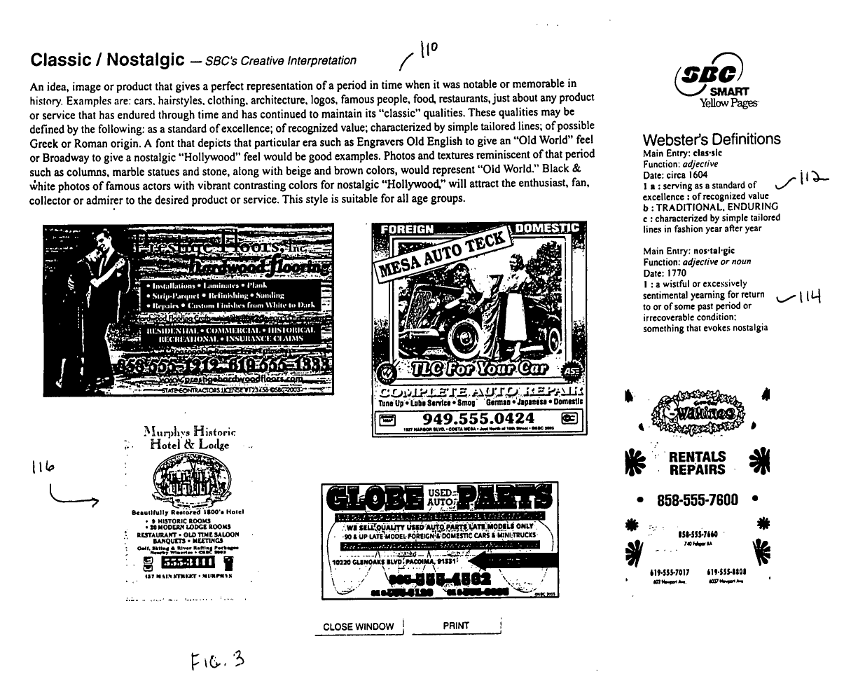

FIG. 3 is a screen shot of an embodiment of a style page corresponding to the classic/nostalgic style. The classic/nostalgic style page is displayed in response to a user selection of link 106 in FIG. 1. The classic/nostalgic style page displays a creative interpretation 110 of classic/nostalgic styles, a definition 112 of classic, a definition 114 of nostalgic, and examples of classic/nostalgic ads 116.

The creative interpretation 110 textually describes classic/nostalgic styles. The creative interpretation 110 describes that this style is suited for “an idea, image or product that gives a perfect representation of a period in time when it was notable or memorable in history.” The creative interpretation 110 further describes that examples include “cars, hairstyles, clothing, architecture, logos, famous people, food, restaurants, just about any product or service that has endured through time and has continued to maintain its ‘classic’ qualities.” The creative interpretation 110 recommends that the designer use a font that depicts a particular era “such an Engravers Old English to give an ‘Old World’ feel or Broadway to give a nostalgic ‘Hollywood’ feel, for example.” The creative interpretation 110 recommends that type of graphics, color and textures that the designer should use. For example, the creative interpretation 110 includes: “Photos and textures reminiscent of that particular period such as columns, marble statues and stone, along with beige and brown colors, would represent ‘Old World.’” Further, the creative interpretation 110 includes: “Black & white photos of famous actors with vibrant contrasting colors for nostalgic ‘Hollywood,’ will attract the enthusiast, fan, collector or admirer to the desired product or service.” The creative interpretation 110 provides targeting information in the sentence: “This style is suitable for all age groups.”

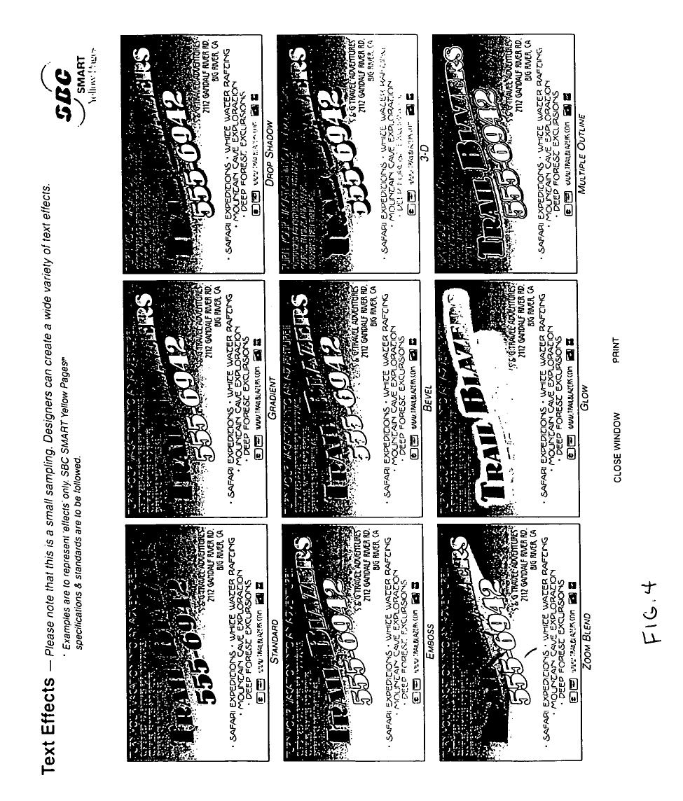

FIG. 4 is a screen shot of an embodiment of a text effects page. The text effects page is displayed in response to a user selection of the link 24 or any of the other text effects links in FIG. 1. The text effects page provides visual examples of text having each of the different text effects, including standard, gradient, drop shadow, emboss, bevel, 3-D, zoom blend, glow and multiple outline.

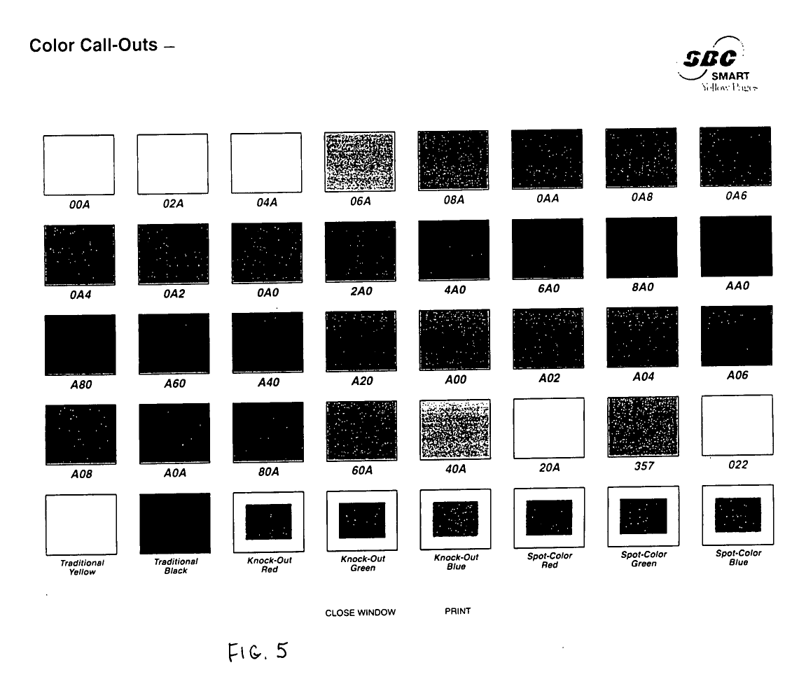

FIG. 5 is a screen shot of an embodiment of a color preferences page. The color preferences page is displayed in response to a user selection of the link 32 in FIG. 1. The color preferences page provides visual examples of the different preferred colors.

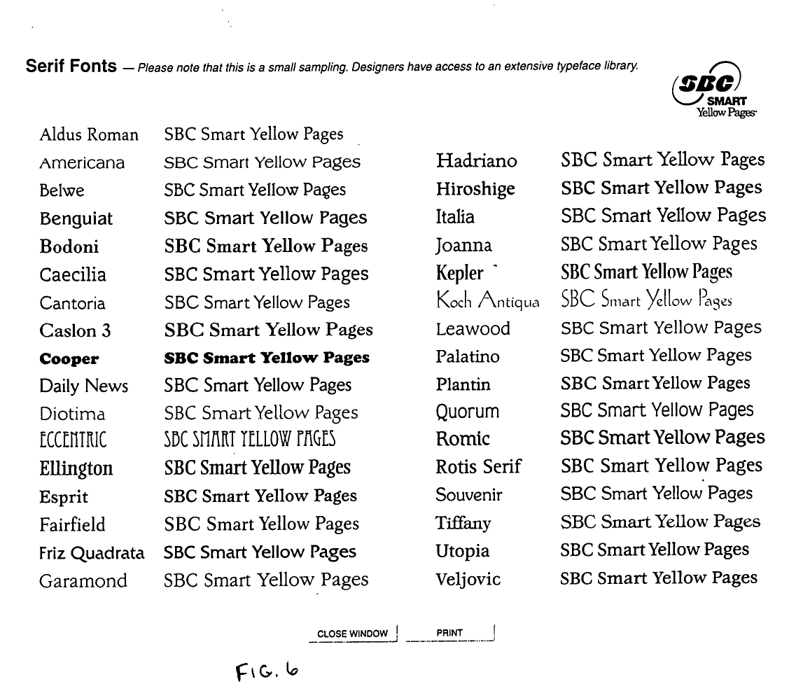

FIG. 6 is a screen shot of an embodiment of a font preferences page. The font preferences page is displayed in response to a user selection of the link 42 in FIG. 1. The font preferences page provides visual examples of the various types of Serif fonts. It is noted that the number of fonts shown in FIG. 6 is a small sample of the full set of about 4300 fonts that are available in one embodiment.

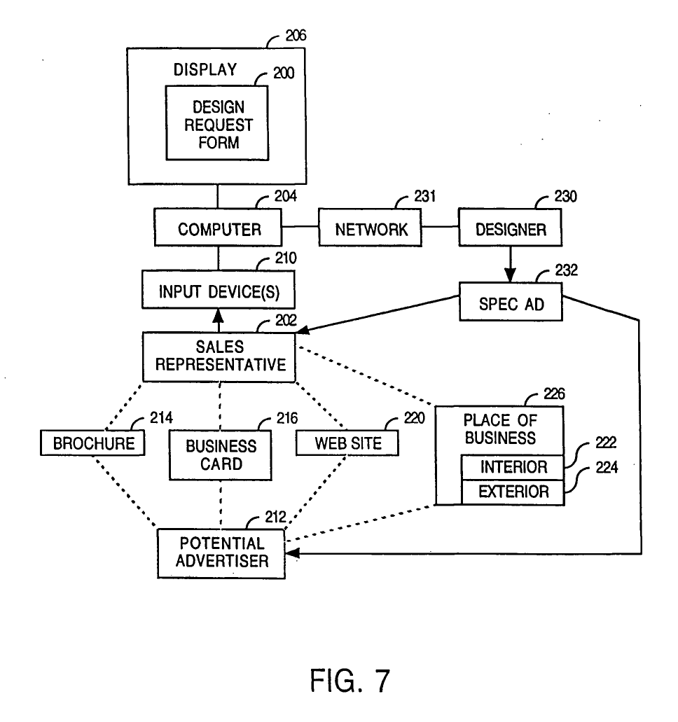

FIG. 7 is a block diagram of a system for using a design request form 200. A sales representative 202 interacts with the design request form 200 using his/her computer 204 (e.g. a notebook computer or a handheld computer). The computer 204 has a display 206 to display the design request form 200, and one or more input devices 210 (e.g. a keyboard, a mouse, a touch pad, a voice input device) to receive user-input from the sales representative 202.

The sales representative 202 can use the design request form 200 as a preparation tool to organize his/her thoughts and ideas prior to a sales contact with a potential advertiser 212. Using as little as a brochure 214, a business card 216, or a website address 220 for the potential advertiser 212, or by observing the interior 222 and/or exterior 224 of the potential advertiser's place of business 226, the sales representative 202 can identify a particular style being projected to attract consumers. In this way, the design request form 200 can be used by the sales representative 202 to confidently approach both existing advertisers, and potential advertisers with no previous history available.

When in contact with the potential advertiser 212, the sales representative 202 can use the design request form 200 as a dynamic, interactive tool to showcase the various styles, looks and feel that can be achieved and delivered to the advertiser 212 through a Yellow Pages® advertisement. If a business has a product or service that is difficult to associate with any of the styles in the style selection portion 10, a new style may be identified and created for the spec ad.

Since the potential advertiser 212 can contribute to the decision-making process to reflect its personal needs and style using the design request form 200, the potential advertiser 212 may be more inclined to purchase a spec ad from the sales representative 202. Further, the potential advertiser 212 may be more inclined to purchase an ad on the spot because of its confidence in the ability of the sales representative 202 to identify and pinpoint their needs using the design request form 200.

After contact with the advertiser 212, the sales representative 202 submits the design request form 200 to a designer 230. The design request form 200 may be submitted to the designer 230 either physically via a printed copy, or by fax, or electronically via a computer network 231 such as an internet, intranet or extranet.

Once the form 200 is submitted, the designer 230 can create a spec ad 232 based on key instructions and design choices, resulting in a focused, high-quality, salable ad with the advertiser's specific needs and style in mind. The designer 230 can refer to one or more of the style pages associated with one or more design styles that are selected when designing the spec ad 232. By providing key information and direction, the design request form 200 allows the designer 230 to work the spec ad 232 to a greater degree of completion with fewer revisions required.

The sales representative 202 can use the design request form 200 to review the spec ad 232 produced by the designer 230. Thus, the design request form 200 is usable by the sales representative 202 before, during, and after the sales contact.

An embodiment of the design request form was used by several sales representatives in their daily sales activities in an experimental trial. Designers used the information provided in the design request form to create spec ads. A follow-up call was made to each sales representative to review the spec ads received from the designers. In this trial, about 85% of the first drafts of the spec ads produced by the designers required minor or no revisions.

Use of the design request form bridges communication gaps that would otherwise exist when attempting to explain the desired look, feel or style or a spec ad to a designer. The design request form provides a common ground of mutual understanding that can be agreed upon by all parties involved in the design process for conveying information such as style, descriptive words, colors, fonts, layout and effects. Consequently, the designer can devote a greater portion of his/her effort on creativity in the design process rather than spending time on preliminary guesswork.

Also, the design request form can be implemented in the Common Suite of Systems (CSS) used in multiple telephone directory regions. The uniformity of the design request form promotes successful designs even if the designer is from a different socioeconomic group and/or different telephone directory region. Thus, some design requests in a high volume region (i.e. a telephone directory region with more design requests than can be desirably fulfilled by its designers) can be forwarded to designers in a lower volume region to produce the spec ads.

It will be apparent to those skilled in the art that the disclosed embodiments may be modified in numerous ways and may assume many embodiments other than the preferred forms specifically set out and described herein.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer-readable medium having computer-readable code stored thereon to provide a design request form which comprises:
a style selection portion having a plurality of user-selectable design styles from which one or more design styles suited to a product, business or service of a potential advertiser in a telephone directory are selectable by a sales representative, the style selection portion providing a plurality of user-selectable links to a plurality of style pages for the design styles, the style pages providing visual representations of sample telephone directory advertisements having the design styles and creative interpretations of the design styles usable by a designer to design a telephone directory advertisement for the potential advertiser based on which one or more design styles are selected.

2. The computer-readable medium of claim 1 wherein the design styles comprise a flashy style, a casual style, an elegant style, a dramatic style, a hip/trendy style, a cutting edge style, a sophisticated style, an upscale/high-end style, a playful/humorous style, a romantic/sensual style, a modern/contemporary style, a classic/nostalgic style, a traditional/conventional style and a professional/legal/medical style.

3. The computer-readable medium of claim 1 wherein at least one of the creative interpretations textually describes at least one suggested font, at least one suggested color, and at least one suggested age group of consumers associated with its design style.

4. The computer-readable medium of claim 1 wherein at least one of the creative interpretations textually describes a type of artwork associated with its design style.

5. The computer-readable medium of claim 1 wherein at least one of the creative interpretations textually describes a type of product associated with its design style.

6. The computer-readable medium of claim 1 wherein at least one of the creative interpretations textually describes how its design style is viewed by consumers when in telephone directories.

7. The computer-readable medium of claim 1 wherein each of the design styles has a respective name, and wherein the style pages further comprise a dictionary definition of each respective name.

8. The computer-readable medium of claim 1 wherein the design request form further comprises:
an art preferences selection portion having a plurality of user-selectable art preferences from which one or more art preferences for the telephone directory advertisement are selectable by the sales representative;
a text effects selection portion having a plurality of user-selectable text effects from which one or more text effects for the telephone directory advertisement are selectable by the sales representative;
a color preferences selection portion having a plurality of user-selectable color preferences from which one or more color preferences for the telephone directory advertisement are selectable by the sales representative; and
a font preferences selection portion having a plurality of user-selectable font preferences from which a font preference for the telephone directory advertisement is selectable by the sales representative.

9. The computer-readable medium of claim 1 wherein the design request form further comprises:
an art preferences selection portion having a plurality of user-selectable art preferences from which one or more art preferences for the telephone directory advertisement are selectable by the sales representative, the user-selectable art preferences including a preference to use of line art, a preference to use of photo(s), a preference to use of product photo(s), a preference to use of background photo(s), and a preference to not use any photo(s).

10. The computer-readable medium of claim 1 wherein the design request form further comprises:
a plurality of user-selectable eras associated with a design style.

11. The computer-readable medium of claim 10 wherein the plurality of user-selectable eras comprises 1920s, 1930s, 1940s, 1950s, 1960s, 1970s, 1980s and Old World.

12. A method comprising:
providing a design request form which comprises a style selection portion having a plurality of user-selectable design styles and a plurality of user-selectable links to a plurality of style pages for the design styles, the style pages providing visual representations of sample telephone directory advertisements having the design styles and creative interpretations of the design styles;
receiving via the design request form a selection by a sales representative of one or more of the design styles suited to a product, business or service of a potential advertiser in a telephone directory; and
submitting the selection of the one or more design styles to a designer.

13. The method of claim 12 further comprising designing, by the designer, a telephone directory advertisement for the potential advertiser based on which one or more design styles that are selected wherein said designing is based on one or more of the style pages associated with the one or more design styles are selected.

14. The method of claim 12 wherein the design styles comprise a flashy style, a casual style, an elegant style, a dramatic style, a hip/trendy style, a cutting edge style, a sophisticated style, an upscale/high-end style, a playful/humorous style, a romantic/sensual style, a modern/contemporary style, a classic/nostalgic style, a traditional/conventional style and a professional/legal/medical style.

15. The method of claim 12 wherein at least one of the creative interpretations textually describes at least one suggested font, at least one suggested color, and at least one suggested age group of consumers associated with its design style.

16. The method of claim 12 wherein at least one of the creative interpretations textually describes a type of artwork associated with its design style.

17. The method of claim 12 wherein at least one of the creative interpretations textually describes a type of product associated with its design style.

18. The method of claim 12 wherein at least one of the creative interpretations textually describes how its design style is viewed by consumers when in telephone directories.

19. The method of claim 12 wherein each of the design styles has a respective name, and wherein the style pages further comprise a dictionary definition of each respective name.
